(19) United States
(12) Patent Application Publication
(10) Pub. No.: US 2016/0092897 A1
(43) Pub. Date: Mar. 31, 2016

(54) PRICING AN API IN AN API MARKETPLACE

(71) Applicant: International Business Machines Corporation, Armonk, NY (US)

(72) Inventors: Arjun Natarajan, Old Tappan, NJ (US); Maja Vukovic, New York, NY (US); Ji Zheng Zhang, Beijing (CN)

(21) Appl. No.: 14/501,551

(22) Filed: Sep. 30, 2014

(51) Int. Cl. G06Q 30/02

(52) U.S. Cl. CPC G06Q 30/0206

(57) ABSTRACT

In an approach to pricing an API, a computer determines whether an application programming interface (API) is published by a developer. Responsive to determining an API is published by the developer, the computer determines one or more characteristics of the API and whether a price history exists for the API. Responsive to determining a price history does exist for the API, the computer determines an initial price for the API. The computer then determines, based, at least in part, on the one or more characteristics of the API and the price history for the API, whether the initial price maximizes a surplus value for a sale of the API.

### BACKGROUND OF THE INVENTION

The present invention relates generally to the field of computer programming, and more particularly to pricing an API in an API marketplace.

An application programming interface (“API”) is a particular set of rules and specifications that a software program can follow to access and make use of the services and resources provided by another particular software program that implements that API. The API specifies how software components interact with each other, and often comes in the form of a library that includes specifications for routines, data structures, object classes, and variables. An API specifies a set of functions and routines that accomplish a task or are allowed to interact with a specific software component, and serves as an interface between different software programs and facilitates their interaction. Publishing an API allows web communities to create open architecture for sharing content between communities and applications. Pricing an API, however, can prove difficult for the provider because an API is not a tangible product.

### SUMMARY

Embodiments of the present invention disclose a method, a computer program product, and a computer system for pricing an application programming interface (API). The method for pricing an API can include one or more computer processors determining whether an application programming interface (API) is published by a developer. The one or more computer processors, responsive to determining an API is published by the developer, determine one or more characteristics of the API and whether a price history exists for the API. Responsive to determining a price history does exist for the API, the one or more computer processors determine an initial price for the API. The one or more computer processors then determine, based, at least in part, on the one or more characteristics of the API and the price history for the API, whether the initial price maximizes a surplus value for a sale of the API.

### BRIEF DESCRIPTION OF THE DRAWINGS

FIG. 1 is a functional block diagram illustrating a data processing environment, in accordance with an embodiment of the present invention;

FIG. 2 is a flowchart depicting operational steps of an API pricing module, for determining a price for an API in a marketplace, in accordance with an embodiment of the present invention;

FIG. 3 illustrates operational steps of a bundling module, for determining a price for a plurality of related APIs in a marketplace, in accordance with an embodiment of the present invention; and

FIG. 4 is a block diagram of components of a data processing system, such as the server computing device of FIG. 1, in accordance with an embodiment of the present invention.

### DETAILED DESCRIPTION

In an API marketplace, at the start of each trading period, participants, including consumers and providers of APIs, are provided with a list of limit prices for each API unit to be bought or sold. For consumers, the limit prices are values, and for providers, the limit prices are costs. The limit prices are held constant in the API marketplace for a predetermined amount of trading periods, for example, a week of trading, and the limit prices maybe be shifted by random amounts to test responsiveness to changing market conditions. Each participant's objective is to maximize surplus, either (limit price−trade price) for consumers or (trade price−limit price) for providers. The limit prices indicate the current valuations of the APIs, and a markup or discount may be set as a percentage of the current valuation at the beginning of the trading period, and may be periodically updated.

Embodiments of the present invention recognize that there is not a system for automatically and systematically pricing APIs that are broadcast by API providers to consumers. Embodiments of the present invention recognize that a system for API pricing can take into account both provider and consumer valuations, in addition to a number of API characteristics. Embodiments also recognize that once an initial price for an API is set, it can be dynamically adjusted.

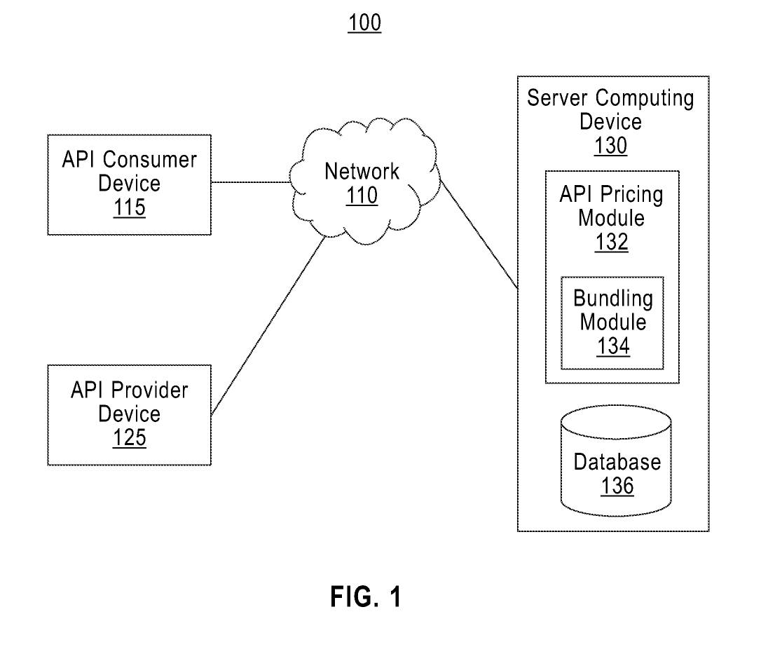

The present invention will now be described in detail with reference to the Figures. FIG. 1 is a functional block diagram illustrating a data processing environment, generally designated 100, in accordance with one embodiment of the present invention. FIG. 1 provides only an illustration of one implementation and does not imply any limitations with regard to the environments in which different embodiments may be made by those skilled in the art without departing from the scope of the invention as recited by the claims.

Data processing environment 100 includes API consumer device 115, API provider device 125, and server computing device 130, all interconnected via network 110. In an embodiment, data processing environment 100 represents an API marketplace. Network 110 can be, for example, a telecommunications network, a local area network (LAN), a wide area network (WAN), such as the Internet, or a combination of the three, and can include wired, wireless, or fiber optic connections. Network 110 may include one or more wired and/or wireless networks that are capable of receiving and transmitting data, voice, and/or video signals, including multimedia signals that include voice, data, and video information.

API consumer device 115 and API provider device 125 may each be a desktop computer, a laptop computer, a tablet computer, a specialized computer server, a smart phone, or any programmable electronic device capable of communicating with each other and with server computing device 130 via network 110. API consumer device 115 provides a user, for example, a consumer or buyer, with the ability to review, utilize, and purchase available APIs published within data processing environment 100. API provider device 125 allows an API developer, publisher, provider, and/or seller to publish an API to data processing environment 100.

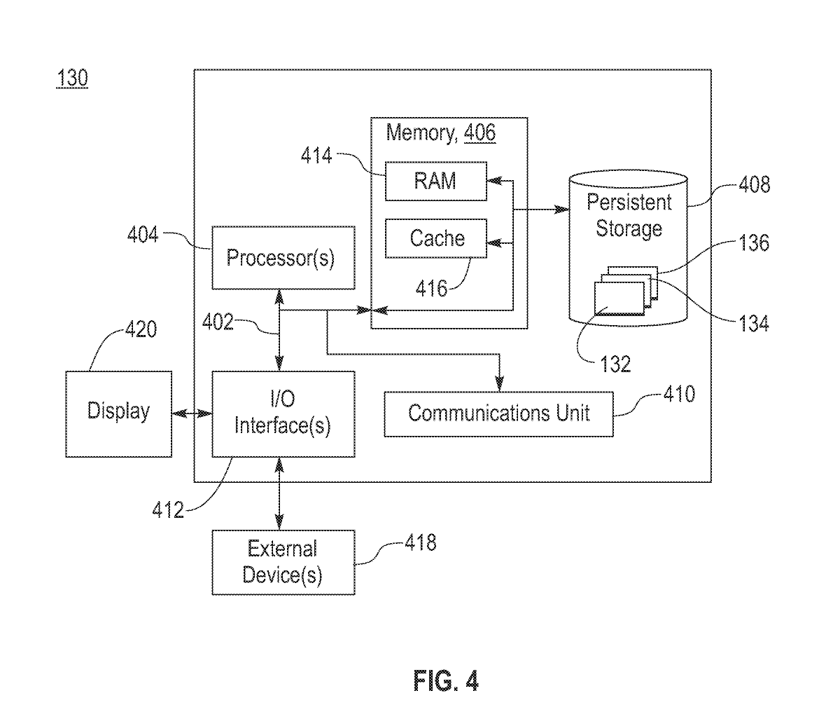

Server computing device 130 includes API pricing module 132, bundling module 134, and database 136. In various embodiments, server computing device 130 can be a management server, a web server, a mobile computing device, or any other electronic device or computing system capable of receiving, sending, and processing data. In other embodiments, server computing device 130 can represent a server computing system utilizing multiple computers as a server system, such as in a cloud computing environment. In another embodiment, server computing device 130 can be a laptop computer, a tablet computer, a netbook computer, a personal computer, a desktop computer, or any programmable electronic device capable of communicating with API consumer device 115, API provider device 125, and other devices present within data processing environment 100 (not shown) via network 110. In another embodiment, server computing device 130 represents a computing system utilizing clustered computers and components (e.g., database server computers, application server computers, etc.) that act as a single pool of seamless resources when accessed within data processing environment 100. In various embodiments, each of the modules and databases included on server computing device 130 may be located elsewhere within data processing environment 100 with access between each other, API consumer device 115, and API provider device 125 via network 110. Server computing device 130 may include internal and external hardware components, as depicted and described with reference to FIG. 4.

API pricing module 132 operates to provide pricing as a service and to guide an API provider in pricing. API pricing module 132 determines a price for an API in a marketplace, based on characteristics of the API, and on characteristics of the marketplace, for example, whether the API represents a monopoly in the marketplace. Bundling module 134 determines a price for a plurality of related APIs, submitted in a bundle by an API provider for pricing in the marketplace.

Database 136 stores historical information for the marketplace, for example, information on pricing history of previously published APIs, and marketplace properties, for example, consumption information, including supply and demand information, of various types of APIs in the marketplace. The historical information may include, among other things, a number of API providers and API consumers in the marketplace, a daily price distribution for an API, a price variance per day, consumer valuation, a preference of a consumer for a certain provider, search terms in the marketplace, and API performance characteristics. While depicted in FIG. 1 as residing on server computing device 130, in various other embodiments, database 136 can reside elsewhere within data processing environment 100. A database is an organized collection of data. Database 136 can be implemented with any type of storage device capable of storing data that can be accessed and utilized by server computing device 130, such as a database server, a hard disk drive, or a flash memory. In other embodiments, database 136 can represent multiple storage devices within server computing device 130.

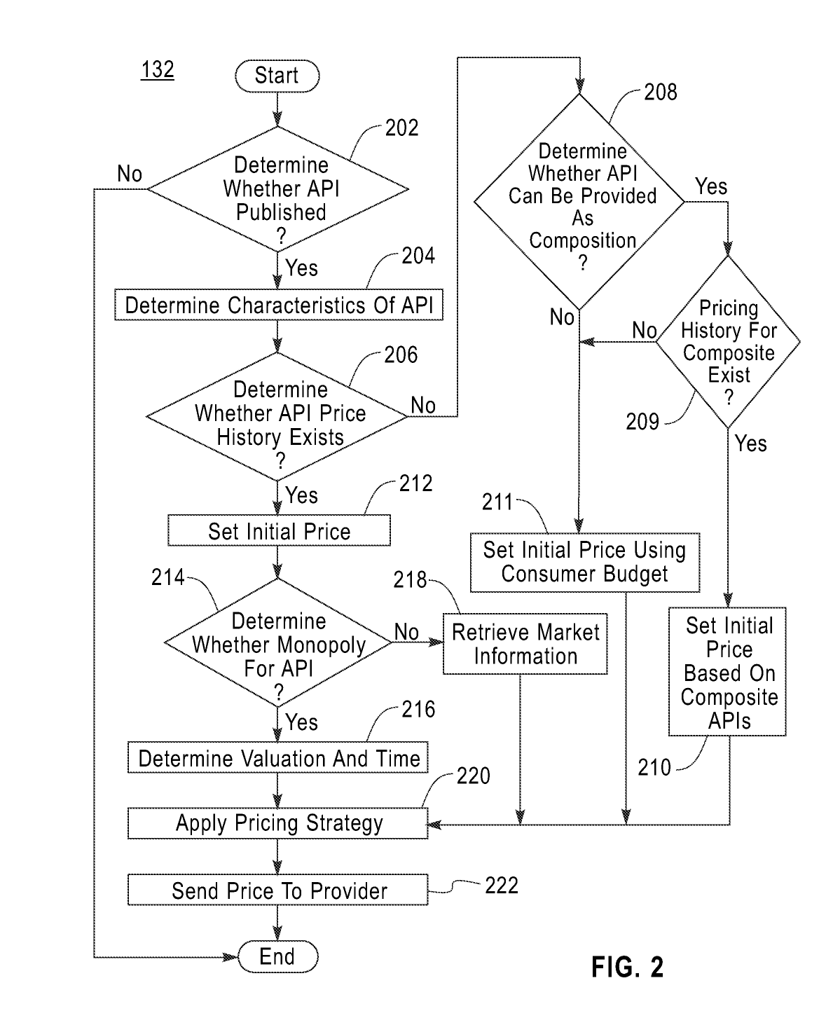

FIG. 2 is a flowchart depicting operational steps of API pricing module 132 for determining a price for an API in a marketplace, in accordance with an embodiment of the present invention.

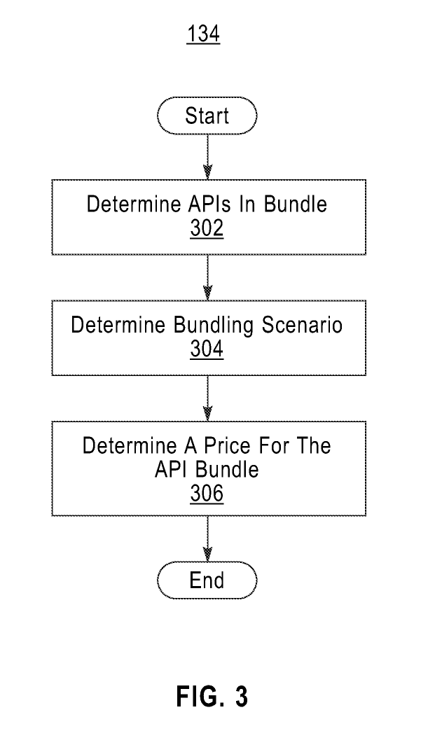

API pricing module 132 determines whether an API is published (decision block 202). An API developer, for example, a user operating API provider device 125, may publish a single API, or a bundle of related APIs to API pricing module 132. In an embodiment, API pricing module 132 can operate as a pricing catalog to which a developer can submit an API to receive guidance in pricing the API, prior to publishing the API to an API marketplace. In various embodiments, if a developer publishes a bundle of related APIs, pricing is determined according to bundling module 134, as discussed with reference to FIG. 3. If an API has not been published (decision block 202, “no” branch), API pricing module 132 does not operate to determine a pricing strategy.

If API pricing module 132 determines an API is published (decision block 202, “yes” branch), then API pricing module 132 determines characteristics of the API (step 204). Characteristics of the API may be provided by the API developer, and may include properties such as quality of service (QoS), time of service (ToS), available programming languages, compatible operating systems, protocols, semantics, and implementations.

API pricing module 132 determines whether a pricing history for the API exists (decision block 206). API pricing module 132 reviews a database, such as database 136, to determine whether a history for pricing of the API is stored. If a pricing history does exist (decision block 206, “yes” branch), then API pricing module 132 sets an initial price for the API equal to the historical price (step 212). If API pricing module 132 identifies more than one historical price for the API, then API pricing module 132 can identify a range of prices, and set an average of the range as the initial price (at step 212).

If a pricing history does not exist (decision block 206, “no” branch), then API pricing module 132 determines whether the API can be provided as a composition (decision block 208). If there is no historical price, API pricing module 132 reviews the determined characteristics to determine whether the API can be provided as a composition to consumers of more than one API. If the API can be provided as a composition (decision block 208, “yes” branch), then API pricing module 132 determines whether a pricing history for the composite APIs exists (decision block 209). If a pricing history for the composition of APIs, or composite API, exists (decision block 209, “yes” branch), then API pricing module 132 sets an initial price based on the historical pricing of the composite APIs (step 210). For example, if a provider has published and requires pricing information for a “monthly payroll API”, but the API marketplace only has historical price information for a “weekly payroll API” and a “week to month conversion API”, API pricing module 132 can determine whether the two APIs with pricing history may be provided as a composite API and their historical prices may be correlated to infer what may be a suitable price for the monthly payroll API. If the API cannot be provided as a composition (decision block 208, “no” branch), or if there is no pricing history for the composite APIs (decision block 209, “no” branch), then API pricing module 132 sets an initial price for the API using a consumer budget (step 211). API pricing module 132 uses a minimum value of the consumer budget to set the initial price. The consumer budget may be obtained by mining past consumption of similar APIs, for example, for an API in a similar category or published by a similar provider.

After setting an initial price for the API based on historical data, API pricing module 132 determines whether a monopoly exists for the API (decision block 214). API pricing module 132 can search the marketplace for APIs in a similar category or from a similar provider to determine whether a monopoly exists. If a monopoly does not exist for the API (decision block 214, “no” branch), then API pricing module 132 retrieves market information for the API (step 218). API pricing module 132 reviews pricing information in the marketplace for APIs with similar properties, for example, targeted at similar consumers, and collects the information from other providers.

If a monopoly does exist for the API (decision block 214, “yes” branch), then API pricing module 132 determines valuation and time for the API (step 216). Valuation and time for the API is determined based on historical data, for example, what was the previous demand for similar types of APIs, and for how long did the demand period last.

API pricing module 132 applies a pricing strategy (step 220). In an embodiment of the present invention, API pricing module 132 sets a price for the API using a Gjerstad-Dickhaut (GD) model, as represented by Formula 1 and Formula 2, as follows. The initial price, set in step 212, is used for initial operation of Formula 1 and Formula 2.

$$\begin{matrix}f ( p ) = \frac{AAG ( p ) + BG ( p )}{AAG ( p ) + BG ( p ) + UAL ( p )} & Formula 1 \\ g ( p ) = p - l & Formula 2\end{matrix}$$

In Formula 1, f(p) provides the probability that a price (p) for an API will be accepted in the marketplace. The value of AAG(p) is the number of accepted APIs in history, H, with price >=(p), BG(p) is the number of consumer API requests in H with price >=(p), and UAL(p) is the number of unaccepted APIs in H with a price <=(p).

In Formula 2, for an API provider participant, g(p) provides the gain from trade, and is equal to price for sellers, p, minus consumer cost, or limit price, l. Limit prices are assigned to each API provider or API consumer participating in the API marketplace. For providers (i.e., sellers), limit price represents value. For consumers (i.e., buyers), limit price represents costs. The aim of the GD model for an API provider is to maximize the expected surplus from a sale of the API by selecting a price, p, that maximizes [g(p)*f(p)]. Surplus, for an API provider, is equal to (trade price−limit price), and is represented by Formula 2 above. In another embodiment, an API consumer in the marketplace is aiming to maximize surplus as well, which for a consumer, surplus is equal to (limit price−trade price). The GD model may be used whether or not there is a pricing history for the API. Where there is no history, the algorithm is based on the limit price, l, and a discount parameter, for example, a percentage of the current valuation of the API (i.e., the limit price).

API pricing module 132 is dynamically adjusted with a change in the marketplace environment. For example, an increase or decrease in the number of incoming requests for pricing of APIs will trigger an adjustment in the pricing or if an API provider is the only one offering a specific API, an adjustment in pricing may be created.

API pricing module 132 sends the price to the provider (step 222). Once a price is determined for the API, the price is transmitted or otherwise communicated to the provider so the provider can set the price when publishing the API within data processing environment 100, for example, to a consumer operating API consumer device 115.

FIG. 3 illustrates operational steps of bundling module 134, for determining a price for a plurality of related APIs in a marketplace, in accordance with an embodiment of the present invention. An API developer can bundle more than one related API, and offer a price for the bundle. In an embodiment of the present invention, API pricing module 132 can trigger operation of bundling module 134 when it is determined a provider has published a plurality of related APIs.

Bundling module 134 determines the APIs in the bundle (step 302). Based on the APIs in each bundle, bundling module 134 can determine characteristics of the APIs that may impact the price, such as, for example, consumers interested in the API bundle and trends that may impact the sale of the bundle.

Bundling module 134 determines a bundling scenario for the API bundle (step 304). Bundling module 134 can provide multiple bundling scenarios for each API bundle, and evaluate a pricing strategy for each bundling scenario. In various embodiments, the API provider makes a final determination of which bundling scenario to proceed with when pricing the API bundle. There are several types of bundling scenarios, including “pure”, where consumers pay a fixed price for all APIs in a bundle, for example, a consumer may subscribe to ‘N’ APIs, and receive a bonus for a certain number of APIs purchased. Another bundling scenario is “linear”, where consumers pay a fixed price for each individual API in the bundle. An additional bundling option is “bonus”, where a consumer may receive incremental rewards to motivate them to subscribe to more APIs in a bundle.

Bundling module 134, based on a determined bundling scenario, determines a price for the bundle (step 306). Bundling module 134 dynamically bundles API patterns and APIs based on current usage of similar APIs, API-pattern relationships, and predicted consumption trends. An API pattern can integrate two APIs to achieve a particular functionality. For each bundling scenario alternative, bundling module 134 runs a number of pricing strategies. In various embodiments, the API provider makes a final determination of which bundling scenario and which pricing strategy to proceed with, based on what characteristic the provider wants to optimize, for example, whether the provider would like to distribute the API bundle to as many consumers as possible, or whether the provider would like to gain a high profit off the API bundle in the marketplace.

FIG. 4 depicts a block diagram of components of server computing device 130 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Server computing device 130 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 414 and cache memory 416. In general, memory 406 can include any suitable volatile or non-volatile computer readable storage media.

API pricing module 132, bundling module 134, and database 136 can be stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including with API consumer device 115 and API provider device 125 within data processing environment 100. In these examples, communications unit 410 includes one or more network interface cards. Communications unit 410 may provide communications through the use of either or both physical and wireless communications links. API pricing module 132, bundling module 134, and database 136 may be downloaded to persistent storage 408 through communications unit 410.

I/O interface(s) 412 allows for input and output of data with other devices that may be connected to server computing device 130. For example, I/O interface 412 may provide a connection to external device(s) 418 such as a keyboard, a keypad, a touch screen, and/or some other suitable input device. External device(s) 418 can also include portable computer readable storage media such as, for example, thumb drives, portable optical or magnetic disks, and memory cards. Software and data used to practice embodiments of the present invention, e.g., API pricing module 132, bundling module 134, and database 136, can be stored on such portable computer readable storage media and can be loaded onto persistent storage 408 via I/O interface(s) 412. I/O interface(s) 412 also connect to a display 420. Display 420 provides a mechanism to display data to a user and may be, for example, a computer monitor or an incorporated display screen, such as is used, for example, in tablet computers and smart phones.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for providing a pricing strategy for an API, the method comprising:
determining, by one or more computer processors, whether an application programming interface (API) is published by a developer;
responsive to determining an API is published by the developer, determining, by one or more computer processors, one or more characteristics of the API;
determining, by one or more computer processors, whether a price history exists for the API;
responsive to determining a price history does exist for the API, determining, by one or more computer processors, an initial price for the API; and
determining, by one or more computer processors, based, at least in part, on the one or more characteristics of the API and the price history for the API, whether the initial price maximizes a surplus value for a sale of the API.

2. The method of claim 1, further comprising:
responsive to determining the initial price maximizes the surplus value for the sale of the API, transmitting, by one or more computer processors, the initial price to the developer.

3. The method of claim 1, further comprising:
responsive to determining the initial price does not maximize the surplus value for the sale of the API, retrieving, by one or more computer processors, historical information, wherein the historical information includes at least a number of consumer API requests with a price greater than the initial price, a number of unaccepted APIs with a price less than the initial price, and a number of accepted APIs with price greater than the initial price; and
determining, by one or more computer processors, based, at least in part, on the historical information, a second price for the API.

4. The method of claim 1, further comprising:
determining, by one or more computer processors, whether there is a monopoly for the API; and
responsive to determining there is not a monopoly for the API, retrieving, by one or more computer processors, market information for the API from one or more additional developers.

5. The method of claim 1, wherein the API is one of a single API, a composite API, and an API pattern.

6. The method of claim 1, further comprising:
responsive to determining a price history does not exist for the API, determining, by one or more computer processors, whether the API can be provided as a composition;
responsive to determining the API can be provided as a composition, determining, by one or more computer processors, whether a price history exists for the composition;
responsive to determining there is no price history for the composition, retrieving, by one or more computer processors, budget information for one or more consumers; and
determining, by one or more computer processors, based, at least in part, on the budget information, an initial price for the API.

7. The method of claim 1, further comprising:
responsive to determining an API is not published by the developer, determining, by one or more computer processors, whether an API bundle is published;
responsive to determining an API bundle is published, determining, by one or more computer processors, a plurality of characteristics of the API bundle; and
determining, by one or more computer processors, based, at least in part on the plurality of characteristics and a plurality of bundling scenarios, an initial price for the API bundle.

8. A computer program product for pricing an API, the computer program product comprising:
one or more computer readable storage media and program instructions stored on the one or more computer readable storage media, the program instructions comprising:
program instructions to determine whether an application programming interface (API) is published by a developer;
responsive to determining an API is published by the developer, program instructions to determine one or more characteristics of the API;
program instructions to determine whether a price history exists for the API;
responsive to determining a price history does exist for the API, program instructions to determine an initial price for the API; and
program instructions to determine, based, at least in part, on the one or more characteristics of the API and the price history for the API, whether the initial price maximizes a surplus value for a sale of the API.

9. The computer program product of claim 8, further comprising:
responsive to determining the initial price maximizes the surplus value for the sale of the API, program instructions to transmit the initial price to the developer.

10. The computer program product of claim 8, further comprising:
responsive to determining the initial price does not maximize the surplus value for the sale of the API, program instructions to retrieve historical information, wherein the historical information includes at least a number of consumer API requests with a price greater than the initial price, a number of unaccepted APIs with a price less than the initial price, and a number of accepted APIs with price greater than the initial price; and
program instructions to determine, based, at least in part, on the historical information, a second price for the API.

11. The computer program product of claim 8, further comprising:
program instructions to determine whether there is a monopoly for the API; and
responsive to determining there is not a monopoly for the API, program instructions to retrieve market information for the API from one or more additional developers.

12. The computer program product of claim 8, wherein the API is one of a single API, a composite API, and an API pattern.

13. The computer program product of claim 8, further comprising:
responsive to determining a price history does not exist for the API, program instructions to determine whether the API can be provided as a composition;
responsive to determining the API can be provided as a composition, program instructions to determine whether a price history exists for the composition;
responsive to determining there is no price history for the composition, program instructions to retrieve budget information for one or more consumers; and
program instructions to determine, based, at least in part, on the budget information, an initial price for the API.

14. The computer program product of claim 8, further comprising:
responsive to determining an API is not published by the developer, program instructions to determine whether an API bundle is published;
responsive to determining an API bundle is published, program instructions to determine a plurality of characteristics of the API bundle; and
program instructions to determine, based, at least in part on the plurality of characteristics and a plurality of bundling scenarios, an initial price for the API bundle.

15. A computer system for pricing an API, the computer system comprising:
one or more computer processors;
one or more computer readable storage media;
program instructions stored on the one or more computer readable storage media for execution by at least one of the one or more computer processors, the program instructions comprising:
program instructions to determine whether an application programming interface (API) is published by a developer;
responsive to determining an API is published by the developer, program instructions to determine one or more characteristics of the API;
program instructions to determine whether a price history exists for the API;
responsive to determining a price history does exist for the API, program instructions to determine an initial price for the API; and
program instructions to determine, based, at least in part, on the one or more characteristics of the API and the price history for the API, whether the initial price maximizes a surplus value for a sale of the API.

16. The computer system of claim 15, further comprising:
responsive to determining the initial price maximizes the surplus value for the sale of the API, program instructions to transmit the initial price to the developer.

17. The computer system of claim 15, further comprising:
responsive to determining the initial price does not maximize the surplus value for the sale of the API, program instructions to retrieve historical information, wherein the historical information includes at least a number of consumer API requests with a price greater than the initial price, a number of unaccepted APIs with a price less than the initial price, and a number of accepted APIs with price greater than the initial price; and
program instructions to determine, based, at least in part, on the historical information, a second price for the API.

18. The computer system of claim 15, further comprising:
program instructions to determine whether there is a monopoly for the API; and
responsive to determining there is not a monopoly for the API, program instructions to retrieve market information for the API from one or more additional developers.

19. The computer system of claim 15, further comprising:
responsive to determining a price history does not exist for the API, program instructions to determine whether the API can be provided as a composition;
responsive to determining the API can be provided as a composition, program instructions to determine whether a price history exists for the composition;
responsive to determining there is no price history for the composition, program instructions to retrieve budget information for one or more consumers; and
program instructions to determine, based, at least in part, on the budget information, an initial price for the API.

20. The computer system of claim 15, further comprising:
responsive to determining an API is not published by the developer, program instructions to determine whether an API bundle is published;
responsive to determining an API bundle is published, program instructions to determine a plurality of characteristics of the API bundle; and
program instructions to determine, based, at least in part on the plurality of characteristics and a plurality of bundling scenarios, an initial price for the API bundle.
